(19) United States
(12) Patent Application Publication
(10) Pub. No.: US 2022/0207636 A1
(43) Pub. Date: Jun. 30, 2022

(54) METHODS AND APPARATUS FOR MANAGING AND ONLINE TRANSACTIONS INVOLVING PERSONAL DATA

(71) Applicant: McAfee, LLC, San Jose, CA (US)

(72) Inventors: Srikanth NALLURI, Bangalore (IN); Dattatraya KULKARNI, Bangalore (IN); Harsha R. JOSHI, Bangalore (IN); Samrat CHITTA, Bengaluru (IN)

(21) Appl. No.: 17/191,665

(22) Filed: Mar. 3, 2021

(30) Foreign Application Priority Data
Dec. 24, 2020 (IN) 202011056259

(51) Int. Cl. G06Q 50/26; G06Q 30/00; G06F 21/62; G06F 9/54

(52) U.S. Cl. CPC G06Q 50/265; G06Q 30/018; G06Q 2220/00; G06F 9/541; G06F 21/6263

(57) ABSTRACT

Methods and apparatus for managing online transactions involving personal data are disclosed. An example non-transitory computer readable medium comprises instructions that, when executed, cause a machine to at least encrypt user personal information for storage in a user information database, identify a request for personal information from a service provider, determine a reputation score of the service provider using a service reputation database, compare the reputation score against a threshold for reputability, cause presentation of a request for approval to provide user information to the service provider, in response to user approval, provide the user information to the service provider, and add the service provider to a list of service providers that have been given access to user information.

### RELATED APPLICATIONS

This patent claims priority to Indian Patent Application Serial Number 202011056259, which was filed on Dec. 24, 2020, and is hereby incorporated herein by reference in its entirety.

### FIELD OF THE DISCLOSURE

This disclosure relates generally to network transactions, to methods and apparatus for managing and online transactions involving personal data.

### BACKGROUND

With the rapid growth in digitization of services in the recent years, the need for transfer of personal information (e.g., home address, bank account numbers, social security number, etc.) to service providers for transactions via the Internet has increased tremendously. Users of online services often visit service providers (e.g., websites) and input (e.g., by typing on a keyboard) their personal information. Some software tools provide tools for storing user personal information

### BRIEF DESCRIPTION OF THE DRAWINGS

FIG. 1 is a block diagram of an example environment in which a privacy orchestration engine operates in association with a privacy orchestration agent in accordance with the teachings of this disclosure.

FIG. 2 illustrates an example implementation of the privacy orchestration agent of FIG. 1 to operate within an example user browser by communicating with service providers.

FIG. 3 is a flowchart representative of machine readable instructions which may be executed to implement the example privacy orchestration agent of FIGS. 1 and/or 2 to transmit information between the user browser, the service provider(s), and the example privacy orchestration engine 130 of FIG. 1.

FIG. 4 is a flowchart representative of machine readable instructions which may be executed to implement the example privacy orchestration engine of FIG. 1 to initiate per service periodic cleaning of personal information.

FIG. 5 is a flowchart representative of machine readable instructions which may be executed to implement the example privacy orchestration engine of FIG. 1 to respond to user initiation of per service periodic cleaning of personal information.

FIG. 6a depicts a flowchart representative of machine readable instructions which may be executed to implement the example privacy orchestration engine of FIG. 1 to receive, encrypt, and store user personal information in the user data collector, to run a service reputation check on a service provider, and to interpret and present a service provider's privacy policy to the user.

FIG. 6b depicts a flowchart representative of machine readable instructions which may be executed to implement the example privacy orchestration engine of FIG. 1 to enable the per service periodic cleaning of personal information, as shown in FIGS. 4 and/or 5, and to transmit data to a service provider using federated identity linking and/or the application programming interface (API) orchestrator.

FIG. 7 is a block diagram of an example processing platform structured to execute the instructions of FIGS. 4, 5, 6a, and/or 6b to implement the privacy orchestration engine 130.

FIG. 8 is a block diagram of an example processing platform structured to execute the instructions of FIG. 3 to implement the privacy orchestration agent 101.

FIG. 9 is a block diagram of an example software distribution platform to distribute software (e.g., software corresponding to the example computer readable instructions of FIG. 3) to client devices such as consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to direct buy consumers).

FIG. 10 is a block diagram of an example software distribution platform to distribute software (e.g., software corresponding to the example computer readable instructions of FIGS. 4, 5, 6a, and/or 6b) to client devices such as consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to direct buy consumers).

The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular. In general, the same reference numbers will be used throughout the drawing(s) and accompanying written description to refer to the same or like parts. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc. are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

When an Internet user visits a service provider website (for at least the first time), they are prompted to enter their personal details (e.g. home address, bank account numbers, social security number, etc.) in exchange for a service. After visiting a few different service provider websites and providing a variety of personal information to each site, the average Internet user begins to lose track of which service providers have received what sensitive information. Being able to identify and keep track of information distribution is important because user personal information could easily be used for fraudulent and/or unwanted activity.

Internet users currently have limited options for verifying the reputation of a service provider before providing personal information, and each service provider has their own version of a lengthy privacy policy written in complicated legal terms that the average Internet user cannot understand. Therefore, when sensitive information is divulged to these service providers, Internet users have little control over how their personal data is handled and for how long the data is retained by each service provider. Internet users often struggle with understanding the terms of a service provider's lengthy privacy policy. In these privacy policies, service providers lay out the details of how they will be handling user personal information and for how long they are entitled to retain a user's sensitive information. Users should be provided the opportunity to fully understand the terms of a service provider's privacy policy before agreeing to it and distributing any personal information to that service provider. However, the complicated and lengthy nature of these service provider privacy policies make it very difficult to do so, resulting in unwanted activity with a user's personal information once it is sent to a service provider.

In addition to carefully reviewing a service provider's privacy policy before sending personal information, it is important for a user to consider the service provider's reputation to ensure that they are trustworthy. If sensitive information is transmitted to an untrustworthy service provider, the user may face fraudulent and/or unwanted activity in relation to their personal data.

Some approaches to prevent malicious, fraudulent, and/or unwanted uses of personal information involve the use of encryption tools to allow for the secure transmission of data from a user to a service provider website. However, this type of secure data transport only refers to the transmission of user information across a secure channel but does not account for the fact that the service provider receiving the data might not be trustworthy. Thus, failure to account for a service provider's ability to misuse a user's personal information may still result in fraudulent and/or unwanted use of data.

Another approach to prevent unwanted uses of user personal information involves using at-risk analysis to determine the locations of vulnerable personal data. However, the ability to simply identify potential weaknesses in data security does not protect a user from unwanted and/or fraudulent uses of personal data. Such an approach of alerting the user to potential vulnerability needs to be paired with an approach to mitigate the concern of fraudulent use(s) of personal information.

Examples disclosed herein include methods and apparatus to manage and protect users' online transactions involving personal data. Examples disclosed herein utilize privacy orchestration techniques such as, for example, encryption, secure data transfer, document object model (DOM) parsing, API management, etc. to manage secure online transactions involving user personal data. As used herein, fraudulent use of data may refer to any unwanted uses of personal information. In some examples, user personal information is encrypted and stored within a database at a privacy orchestration engine. The privacy orchestration engine may interact with a privacy orchestration agent at a client device (e.g., operating within a browser at the client device). In some examples, a reputation score of a service provider is determined by the privacy orchestration engine and/or the privacy orchestration agent using reputation data stored in a service reputation database. The reputation score may be compared with a threshold to determine if the privacy orchestration agent should provide the user personal information to a service provider. If information is presented to a service provider by the privacy orchestration agent, an indication of such presentation is recorded and a list is maintained. Accordingly, at a later time a user may determine that information that the information previously presented is to be revoked.

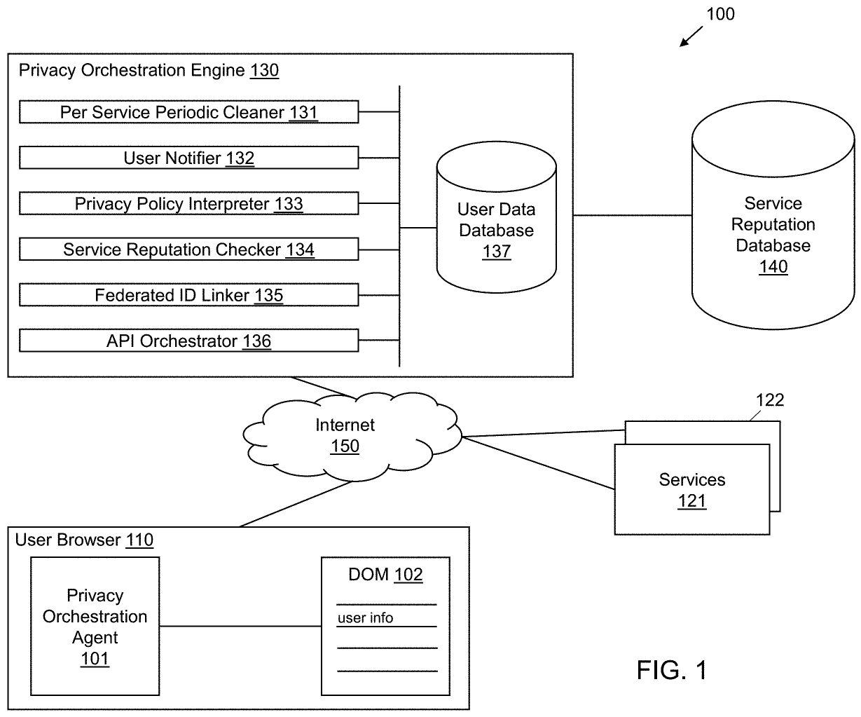

FIG. 1 is a block diagram of an example environment 100 that operates in accordance with the teachings of this disclosure. The example environment 100 includes an example user browser 110, an example set of service provider websites 120, an example privacy orchestration engine 130, and an example service reputation database 140. The example user browser 110 includes an example privacy orchestration agent 101, associated with an example DOM 102. The example set of service provider websites 120 includes an example first service provider website 121 and an example second service provider website 122. The example privacy orchestration engine 130 includes an example per service periodic cleaner 131, an example engine user notifier 132, an example privacy policy interpreter 133, an example service reputation checker 134, an example federated identifier (ID) linker 135, an example API orchestrator 136, and an example user data database 137.

The example user browser 110 is software executing on a computing device that is operated by a user to access one or more service provider websites 120 (e.g., the first service provider website 121 and/or the second service provider website 122) via the Internet 150. The user browser 110 is in communication with the Internet 150 via a network interface (e.g., an ethernet network Interface, a wireless network interface, etc.).

The example privacy orchestration agent 101 is a browser extension that operates in connection with the example privacy orchestration engine 130 to facilitate collection of user data, input of user data into service provider interfaces, and revocation of user information from service providers. The privacy orchestration agent 101 may be implemented as a standalone application (e.g., executing on the same computing device on which the example user browser 110 executes), a mobile application, and/or any type of plugin, extension, add on, etc.

The example DOM 102 is a software interface that represents a document (e.g., a webpage from a service provider) as a logical tree of nodes corresponding to the objects in a webpage. The DOM 102 facilitates the privacy orchestration agent 101 to parse a webpage and recognize components of the webpage (e.g., input fields, form fields, privacy policy information, etc.).

The example privacy orchestration engine 130 manages the collection, storage, and removal of user information and the distribution of user information to and revocation from the service providers 120. The example privacy orchestration engine is a service hosted with in a cloud coupled to the Internet 150. Alternatively, the privacy orchestration engine may be hosted locally to the user browser 110, may be implemented on a same computing device as the user browser 110, or any or location at which the privacy orchestration agent 101 may communicate with the privacy orchestration engine 130.

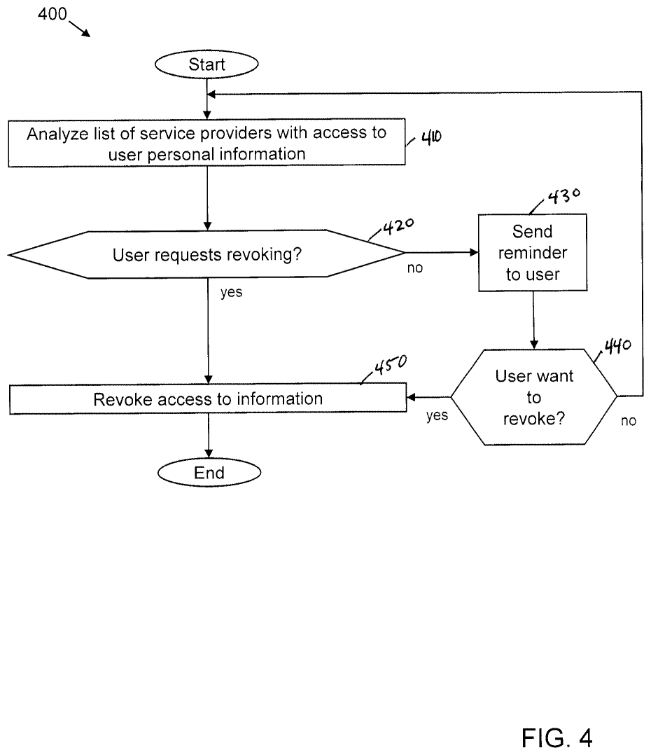

The example per service periodic cleaner 131 of FIG. 1 manages the revocation of access to user personal information from service providers and/or to respond to a user request for revocation. The example per service periodic cleaner 131 of the illustrated example of FIG. 1 revokes data by no longer decrypting user personal data each time the data is to be used by a service provider. By only allowing a service provider to have access to encrypted user personal data, the per service periodic cleaner 131 may easily stop the decryption process to revoke, at any time, a service provider's ability to access user personal information. The per service periodic cleaner 131 is described in further detail below in connection with FIGS. 4 and/or 5.

The example engine user notifier 132 of FIG. 1 sends reminders to the user to revoke access to personal information from service providers, warn the user about the reputability of a service provider before sending personal information, present requests to the user for approval of the transmission of information to a service provider, and/or prompt the user to enter necessary personal information that is not already stored at the privacy orchestration engine 130 via a graphical user interface. The engine user notifier 132 may also provide a popup, alert, banner, window, overlap, etc. on a user's computing device (e.g., inside or outside of the example user browser 110) to notify the user of at least one of the foregoing events and actions.

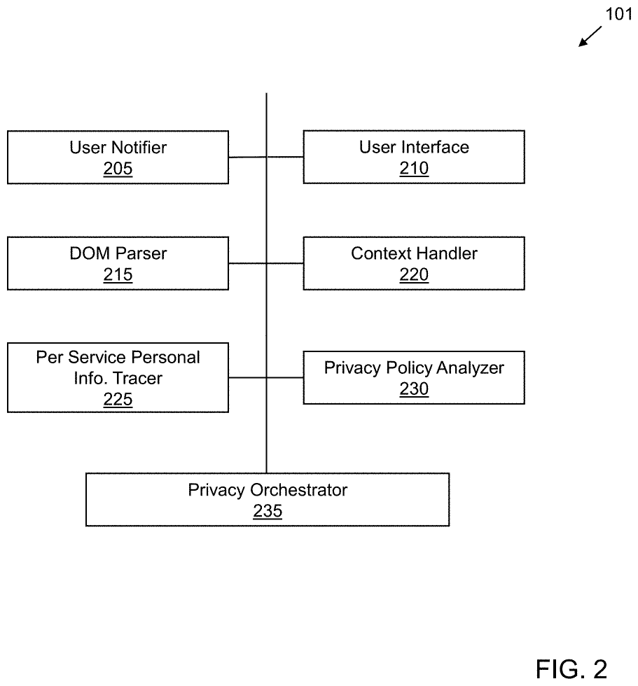

The example privacy policy interpreter 133 is parses a service provider's 120 privacy policy and returns the parsed privacy policy to the privacy orchestration agent 101 for further analysis. The privacy policy interpreter 133 may be implemented by first tokenizing each line of the input, then scanning the tokens and producing a parsed file to send to the privacy policy analyzer 230 for further analysis. The privacy policy analyzer is described in further detail in conjunction with FIG. 2.

The example service reputation checker 134 verifies a service provider's reputation when the privacy orchestration engine 130 receives a request from the privacy orchestration agent 101 for a service reputation check for an indicated service provider 121, 122. The service reputation checker 134 retrieves the compiled reputation details for that service provider from the service reputation database 140, analyzes those details, and returns a reputation score for that service provider 121, 122. In the examples disclosed herein, the analysis of the reputation of a service provider 121, 122 is broken down into categories including range of device permissions, distribution of personal user data to third party advertisers, cross-website tracking of users, etc. Once a score is compiled for each category affecting reputability, the service reputation checker 134 generates a cumulative reputation score based on the category results. That score and the according details for each category of reputability are then sent to a user via the graphical user interface.

The example federated identity linker 135 manages shared information between multiple unrelated sources, allowing for the easy distribution and revocation of user personal data to and/or from service providers 121, 122. The federated identity linker 135 recognizes stored user credentials and applies those credentials, when requested by the user, to a service provider's (e.g., the services providers 121, 122) website if the website is compatible with identity federation. This process allows for the secure distribution of user personal information while eliminating the need for a user to re-enter information across different service provider websites.

The example API orchestrator 136 maintains identification of how the privacy orchestration engine 130 communicates with service provider websites 120. Some service provider websites utilize an API framework to allow for the easy transfer of data between multiple websites, but not all service provider websites use an API. In the examples disclosed herein, the API orchestrator 136 identifies when an API is in use by a service provider website to allow for simple distribution of user personal information, when requested by the user.

The example user data database 137 stores collected user data in a database. Alternatively, the user data database 137 may be any type of datastore such as a file(s), a storage disk, a directory, etc. The example service reputation database 140 stores information about service providers and service provider reputation information in a database. Alternatively, the service reputation database 140 may be any type of datastore such as a file(s), a storage disk, a directory, etc. While the illustrated example, includes a separate user data database 137 and service reputation database 140, the databases may be combined in a single database or datastore.

While the example of FIG. 1 communicatively couples components via the Internet 150, any one or more networks of one or more types may be utilized. For example, the Internet 150 may be implemented by any combination of local area networks, wide area networks, wired networks, wireless networks, etc.

FIG. 2 illustrates an example implementation of the privacy orchestration agent 101 of FIG. 1 to operate within an example user browser 110 and to communicate with service providers 120 via the Internet 150. The privacy orchestration agent 101 of FIG. 2 includes an example agent user notifier 205 to communicate with the user, an example user interface 210 to present information to the user, an example DOM parser 215 to examine the form field(s) of a service provider website, an example context handler 220 to identify the user's context, an example per service personal information tracer 255 to record which service providers have had access to user personal information, an example privacy policy analyzer 230 to break down a service provider's parsed privacy policy into actionable items, and an example privacy orchestrator 235 to communicate with the privacy orchestration engine 130 of FIG. 1.

The example agent user notifier 205 informs the user of a service provider's reputation before distributing any personal information via, for example, presenting to the user a simplified version of a service provider's privacy policy. The agent user notifier 205 may provide a notice in the form of a popup, alert, banner, window, etc. on a user's computing device to notify the user of a service provider's reputation.

The example user interface 210 displays to the user the aggregate information regarding which service providers have been presented with (e.g., sent) personal information and/or requests for approval for the transmission of information, warnings about the reputability of a service provider, etc. In the examples disclosed herein, the user interface 210 may be implemented in the form of a dashboard showing the name of each service provider with current access to user personal information, the types of information each service provider has received (e.g., addresses, credit card numbers, emails, etc.), the credibility details of each service provider, and an option to request the revocation of data from any service provider.

The example DOM parser 215 analyzes form field(s) in the service provider websites 120 to determine the types of personal information required by the service providers 120. In the examples disclosed herein, the DOM parser 215 breaks down each element of a form field by traversing an input file and creating an object graph in memory to map each corresponding element of the input file. Once this is one, the DOM parser 215 auto-fills the relevant user personal information in a service provider's 120 website, with approval from the user.

The example context handler 220 is to identify the current context of the user (e.g., state of the user actions including data input, submission, etc.). In some examples, the context handler 220 identifies that the user is now entering their social security information in a form field, determines that the user is on a login page and needs to enter some personal information, concludes if providing certain information to a service provider is mandatory, and/or identifies each individual element of a form field (e.g., email, phone number, credit card, etc. fields).

The example per service personal information tracer 225 records the details of personal information transmission to a service provider including at least when a user grants permission for transmission, which service provider is gaining access to personal information, and/or what information was sent to a service provider. In the examples disclosed herein, the per service personal information tracer 225 records the information that is collected and sent to the per service personal information tracer 225 by the privacy orchestrator 235 from FIG. 2. Each time user personal details are distributed to a service provider, the privacy orchestrator 235 stores the details of the transaction (e.g., the name of the service provider, the information that was sent to the service provider, etc.) and transmits that information to the per service personal information tracer 225 to be stored.

The example privacy policy analyzer 230 is to receive a parsed privacy policy from the privacy policy interpreter 133 of FIG. 1, break down the received policy into actionable items, and present these simplified actions to the user for review and approval via a graphical user interface. In the examples disclosed herein, the privacy policy analyzer 230 receives the parsed privacy policy file from the privacy policy interpreter 133 of FIG. 1. The privacy policy analyzer 230 scans the tokens that were created by the privacy policy interpreter 133 and produces the parsing result of a simplified service provider privacy policy with key actionable items for the user to review.

The example privacy orchestrator 235 relays data and information between the privacy orchestration agent 101 of FIGS. 1 and/or 2 and the privacy orchestration engine 130 of FIG. 1. In the examples disclosed herein, the privacy orchestrator 235 records the details of a transaction of user personal information sent to a service provider (e.g., name of the service provider, information that was sent, when the information was sent, etc.) by monitoring the data that is being sent. The privacy orchestrator 235 also presents the service reputation checker 134 of FIG. 1 with a request for a service provider reputation check in the form of a query. Responsive to the results of the query, the privacy orchestrator 235 compares the overall reputability score calculated by the service reputation checker 134 against a threshold for reputability, and informs the user of the results via a graphical user interface or other system of notification (e.g., a message).

While an example manner of implementing the privacy orchestration agent 101 of FIG. 1 is illustrated in FIG. 2, one or more of the elements, processes and/or devices illustrated in FIG. 2 may be combined, divided, re-arranged, omitted, eliminated and/or implemented in any other way. Further, the example agent user notifier 205, the example user interface 210, the example DOM parser 215, the example context handler 220, the example per service personal information tracer 225, the example privacy policy analyzer 230, the example privacy orchestrator 235, and/or, more generally, the example privacy orchestration agent 101 of FIG. 2 may be implemented by hardware, software, firmware and/or any combination of hardware, software and/or firmware. Thus, for example, any of the example agent user notifier 205, the example user interface 210, the example DOM parser 215, the example context handler 220, the example per service personal information tracer 225, the example privacy policy analyzer 230, the example privacy orchestrator 235 and/or, more generally, the example privacy orchestration agent 101 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example agent user notifier 205, the example user interface 210, the example DOM parser 215, the example context handler 220, the example per service information tracer 225, the example privacy policy analyzer 230, and/or the example privacy orchestrator 235 is/are hereby expressly defined to include a non-transitory computer readable storage device or storage disk such as a memory, a digital versatile disk (DVD), a compact disk (CD), a Blu-ray disk, etc. including the software and/or firmware. Further still, the example privacy orchestration agent 101 of FIG. 1 may include one or more elements, processes and/or devices in addition to, or instead of, those illustrated in FIG. 2, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

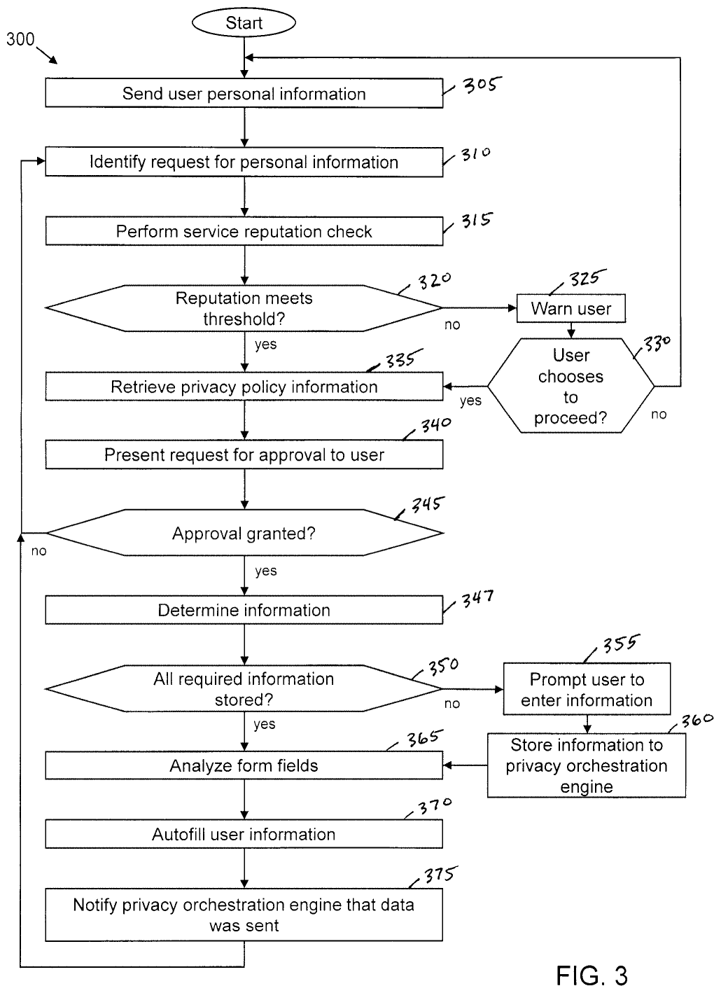

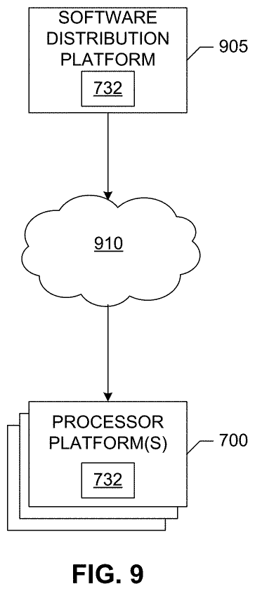

A flowchart representative of example hardware logic, machine readable instructions, hardware implemented state machines, and/or any combination thereof for implementing the privacy orchestration agent 101 of FIG. 1 is shown in FIG. 3. The machine readable instructions may be one or more executable programs or portion(s) of an executable program for execution by a computer processor and/or processor circuitry, such as the processor 712 shown in the example processor platform 700 discussed below in connection with FIG. 9. The program may be embodied in software stored on a non-transitory computer readable storage medium such as a CD-ROM, a floppy disk, a hard drive, a DVD, a Blu-ray disk, or a memory associated with the processor 712, but the entire program and/or parts thereof could alternatively be executed by a device other than the processor 712 and/or embodied in firmware or dedicated hardware. Further, although the example program is described with reference to the flowchart illustrated in FIG. 3, many other methods of implementing the example privacy orchestration agent 101 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

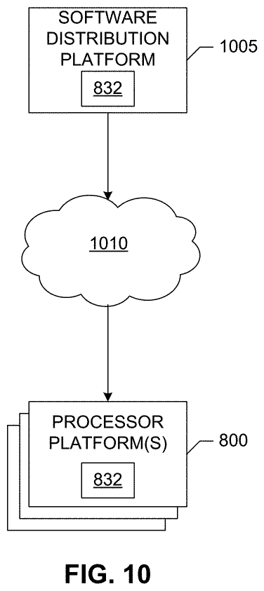

A flowchart representative of example hardware logic, machine readable instructions, hardware implemented state machines, and/or any combination thereof for implementing the privacy orchestration engine 130 of FIG. 1 is shown in FIGS. 4-6b. The machine readable instructions may be one or more executable programs or portion(s) of an executable program for execution by a computer processor and/or processor circuitry, such as the processor 812 shown in the example processor platform 800 discussed below in connection with FIG. 10. The program may be embodied in software stored on a non-transitory computer readable storage medium such as a CD-ROM, a floppy disk, a hard drive, a DVD, a Blu-ray disk, or a memory associated with the processor 812, but the entire program and/or parts thereof could alternatively be executed by a device other than the processor 812 and/or embodied in firmware or dedicated hardware. Further, although the example program is described with reference to the flowchart illustrated in FIGS. 4-6b, many other methods of implementing the example privacy orchestration engine 130 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or another machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 3-6b may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 3 is a flowchart representative of example machine readable instructions 300 that may be executed by a processor to implement the example privacy orchestration agent 101 of FIGS. 1 and/or 2 to transmit information to the service provider(s) 120 and/or the example privacy orchestration engine 130 of FIG. 1.

As illustrated in FIG. 3, at block 305, the privacy orchestrator 235 sends personal information input by a user to the user data database 137 via the user interface 210 of FIG. 2. The user data database 137 of FIG. 1 stores and encrypts the user personal information.

At block 310, the example context handler 220 identifies a request for personal information requested by the service provider(s) 120. For example, the context handler 220 may detect a form field of a webpage that requests user personal information such as (e.g., username, name, address, etc.).

At block 315, the privacy orchestrator 235 sends a request for a service reputation check to the service reputation checker 134 of FIG. 1, which retrieves information from the service reputation database 140 of FIG. 1 provides reputability details and an overall reputation score in response.

At block 320, the privacy orchestrator 235 analyzes whether the service provider's reputation meets and/or is above a threshold for reputability. In examples disclosed herein, the threshold for reputability is preset by the privacy orchestration engine 130 of FIG. 1.

If the service providers reputation does not meet the threshold (block 320), the agent user notifier 205 warns the user (block 325). In examples disclosed herein, the user is warned of an inadequate reputation via the user interface 210. The agent user notifier 205 determines if a user wishes to proceed with sharing their sensitive information despite the warning (e.g., the user provides an input asking to proceed) (block 330). If the user does not wish to proceed, control returns to block 305, and no personal information will be sent to the service provider.

In the event the user wishes to proceed with providing their personal information to the service provider despite the warning (e.g., yes at block 330) or the reputation met the threshold for reputability (e.g., yes at block 320), control moves to block 335.

At block 335, the privacy policy analyzer 230 gathers a service provider's privacy policy from their website, sends the full privacy policy to the privacy policy interpreter 133 of FIG. 1 for parsing, and analyzes the parsed privacy policy to break it down into actionable items to present to the user via the user interface 210.

At block 340, the agent user notifier 205 presents a request for approval to send personal information to the indicated service provider. In examples disclosed herein, this request for approval is presented to the user via the user interface 210.

At block 345, the user interface 210 determines whether the user has granted approval for the transmission of personal data to the service provider. In the event that approval is granted via the user interface 210 (e.g., the control of block 345 returns a result of YES), the process moves on to block 347.

Alternatively, in the event the user interface 210 determines that approval is not granted via the user interface 210 (e.g., the control of block 345 returns a result of NO), the process returns to block 310.

At block 347, the context handler 220 determines the personal information to be sent to the service provider 120 in exchange for a service (e.g., the information required and/or requested by the service provider 120 in exchange for providing a service).

At block 350, the privacy orchestrator 235 determines whether all of the required information has already been stored in the user data database 137 of FIG. 1 and can be retrieved. In the event that the privacy orchestrator 235 determines that all of the required information is stored (e.g., the control of block 350 returned a result of YES), the process moves on to block 365.

Alternatively, in the event that the privacy orchestrator 235 determines that all of the information required by the service provider is not stored (e.g., the control of block 350 returns a result of NO), the process moves on to block 355.

At block 355, the user interface 210 prompts the user to enter the required data that has not already been collected and stored. The user interface 210 may additionally display the previously stored information to allow the user to edit the existing information.

The collected information is transmitted to the user data database 137 by the privacy orchestrator 235 for storage in the user data database 137 of the privacy orchestration engine 130 (block 360).

After the needed information is collected and stored (block 360) or if the required information was already stored (block 350), the DOM parser 215 analyzes the form field(s) of the service provider's website to determine what type (e.g., a user name field, a password field, an address field, etc.) of information each portion of the form is requesting.

The DOM parser 215 auto-fills each portion of the form field with user personal information (Block 370).

At block 375, the privacy orchestrator 235 informs the per service periodic cleaner 131 of FIG. 1 of the details of data transmission to a service provider 120 for logging the information of the transmission. In the example disclosed herein, the privacy orchestrator 235 is to at least send the name of the service provider, the time at which information was sent to the service provider, and/or what information was disclosed to the service provider. Control then returns to block 310 to await a further request for personal information.5

FIG. 4 is a flowchart representative of machine readable instructions which may be executed to implement the example privacy orchestration engine 130 of FIG. 1 to initiate per service periodic cleaning of personal information.

As FIG. 4 illustrates, at block 410, the per service periodic cleaner 131 analyzes the list of service providers that have been granted access to user personal information. In the examples disclosed herein, the privacy orchestrator 235 of FIG. 2 records the details of personal information transmission and sends those details to the per service periodic cleaner 131 to add to the list.

At block 420, the privacy orchestration engine 130 of FIG. 1 determines whether the user initiated a request for the revocation of personal information from a service provider. In the event that the privacy orchestration engine 130 determines that the user initiated a request for revocation of personal data from a service provider (e.g., the control of block 420 returns a result of YES), the process moves on to block 450.

Alternatively, in the event that the privacy orchestration engine 130 determines that the user did not initiate a request for the revocation of personal information from a service provider (e.g., the control of block 420 returns a result of NO), the process moves on to block 430.

At block 430, the user notifier sends a reminder to the user to request the revocation of personal information from a service provider. In examples disclosed herein, the reminder to the user to prompt revocation of personal information is sent via the engine user notifier 132 of FIG. 1.

Responsive to the execution of the instructions represented in block 430, the per service periodic cleaner 131 of FIG. 1 determines whether the user wishes to revoke a service provider's access to their personal information. In the event that the per service periodic cleaner 131 determines that the user wants to initiate revocation (e.g., the control of block 440 returns a result of YES), the process moves onto to block 450.

Alternatively, in the event that the per service periodic cleaner 131 of FIG. 1 determines that the user does not wish to revoke a service provider's access to their personal information (e.g., the control of block 440 returns a result of NO), the process returns to block 410.

At block 450, the per service periodic cleaner 131 revokes a service provider's access to a user's personal information, and the process stops.

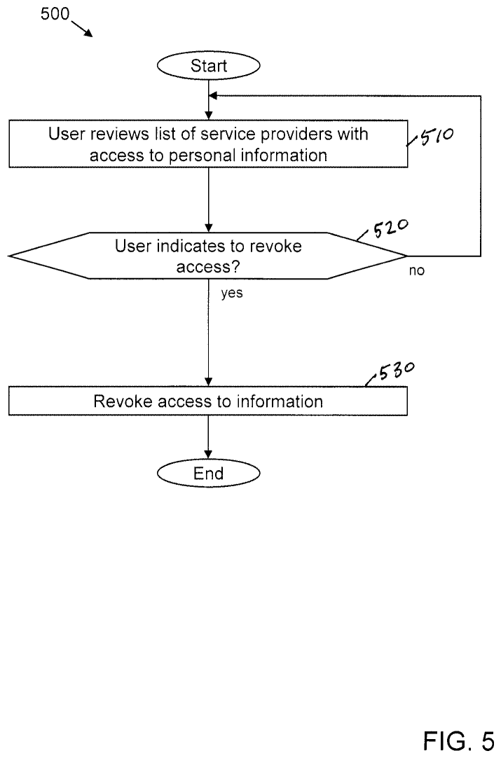

FIG. 5 is a flowchart representative of machine readable instructions which may be executed to implement the example privacy orchestration engine 130 of FIG. 1 to respond to user initiation of the per service periodic cleaner 131 to revoke a service provider's access to user personal information.

As illustrated in FIG. 5, at block 510, the user reviews the list of service providers with access to their personal information. In the example disclosed herein, this list of service providers with access to user personal information is presented to the user via the user browser 101 of FIG. 2.

At block 520, the engine user notifier 132 determines whether the user wishes to revoke a service provider's access to personal information. In the event that the engine user notifier 132 determines that the user does wish to revoke a service provider's access to their personal information (e.g., the control of block 520 returns a result of YES), the process moves on to block 530.

Alternatively, in the event that the engine user notifier 132 determines that the user does not wish to revoke a service provider's access to their personal information (e.g., the control of block 520 returns a result of NO), the process returns to block 510.

At block 530, the per service periodic cleaner 131 revokes a service provider's access to a user's personal information. The process is then stopped.

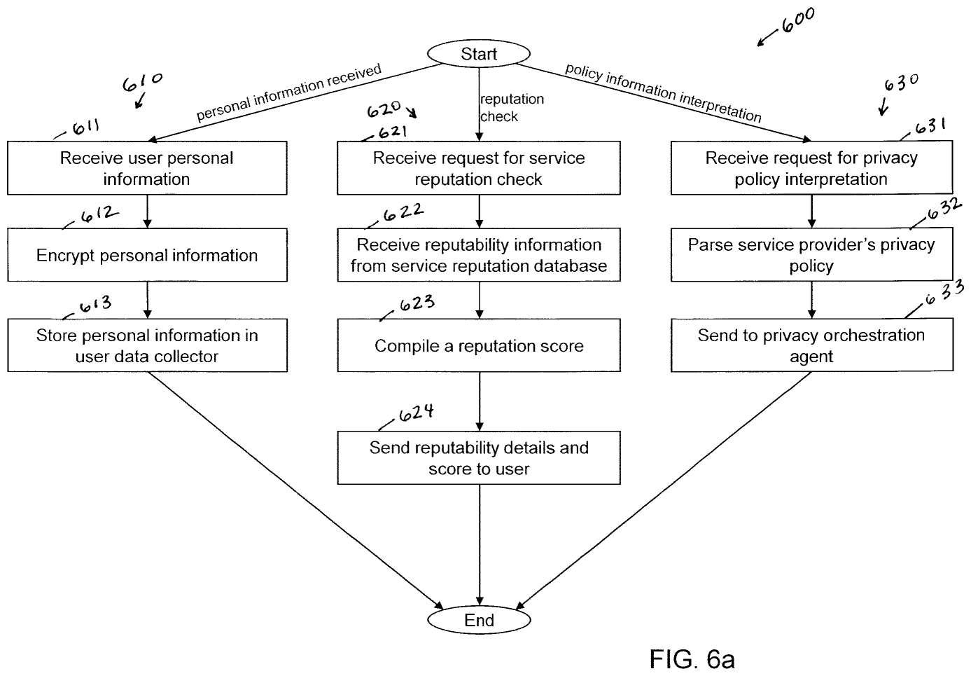

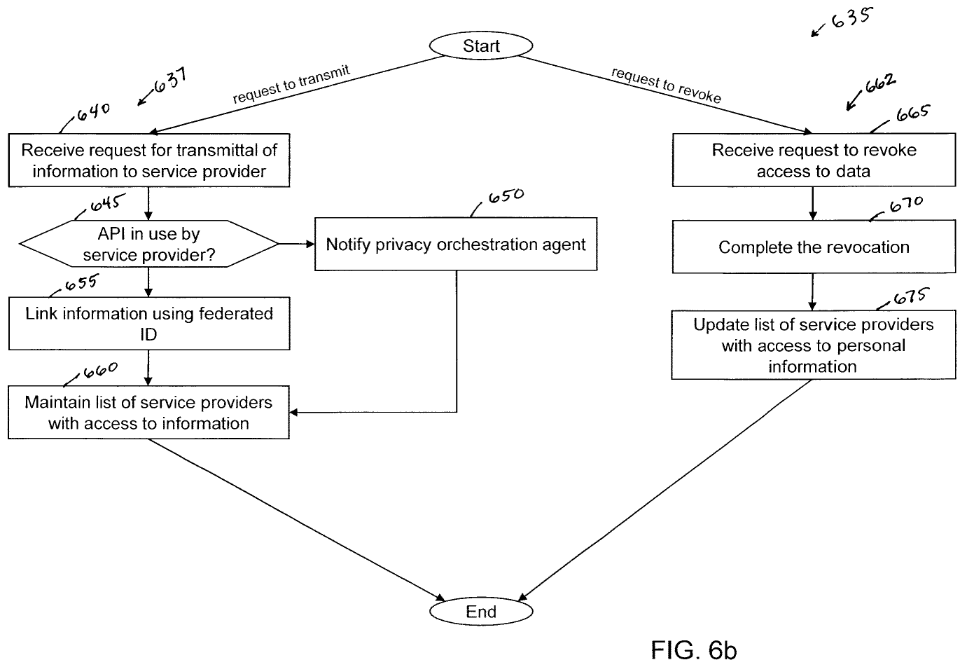

FIG. 6a is a flowchart representative of machine readable instructions 600 which may be executed to implement the example privacy orchestration engine 130 of FIG. 1 to receive, encrypt, and store user personal information in the user data collector, to run a service reputation check on a service provider, and to interpret and present a service provider's privacy policy to the user.

As illustrated in FIG. 6a, at subsection 610, the user data database 137 receives a set of user personal information. In the example disclosed herein, the user data database 137 receives this information from the privacy orchestration agent 101 of FIGS. 1 and/or 2.

Subsection 610 begins at block 611, where the user data database 137 encrypts the user personal data that was received.

Responsive to the instructions executed in block 611, at block 612, the user data database 137 stores the encrypted version of the user personal information. Process 600 is then stopped.

Subsection 620 begins at block 621, where the service reputation checker 134 receives a request for a service reputation check for a service provider. In the example disclosed herein, the request for a service reputation check is sent to the service reputation checker 134 by the privacy orchestration agent 101 of FIGS. 1 and/or 2.

At block 622, the service reputation checker 134 retrieves a service provider's reputation details. In the example disclosed herein, the service reputation checker 134 retrieves the reputability information from the service reputation database 140 of FIG. 1.

At block 623, the service reputation checker 134 analyzes the retrieved service reputation data and compiles an overall reputation score for the service provider.

Responsive to the instructions executed in block 623, at block 624, the user notifier 132 sends the reputability details and overall reputation score of the service provider to the user. In the example disclosed herein, the reputation details and score are presented to the user via a user interface (e.g., a graphical user interface). Process 600 is then stopped.

Subsection 630 begins at block 631, where the privacy policy interpreter 133 receives a request for a service provider's policy interpretation, along with the full privacy policy of the service provider. In the example disclosed herein, the privacy policy interpreter 133 receives both the request for interpretation and the full privacy policy of the service provider from the privacy orchestration agent 101 of FIGS. 1 and/or 2.

At block 632, the privacy policy interpreter 133 parses the full privacy policy of the service provider by reading in a data stream from the provided text and producing a memory model of the conceptual content of the text.

Responsive to the instructions executed at block 632, the privacy policy interpreter 133 sends the parsed privacy policy of the service provider to the privacy orchestration agent 101 be analyzed and broken down into actionable items to present to the user (Block 633). In the example disclosed herein, the parsed privacy policy of the service provider is sent to the privacy policy analyzer 230 of FIG. 2. Process 600 is then stopped.

FIG. 6b is a flowchart representative of machine readable instructions 635 which may be executed to implement the example privacy orchestration engine 130 to perform federated identity linking to improve the efficiency of data transmittal across different service provider websites and to perform the revocation of a service provider's access to user personal data.

Subsection 637 begins at block 640, wherein the privacy orchestration engine 130 receives a request for the transmittal of user personal information to a service provider. In the examples disclosed herein, this request is sent to the privacy orchestration engine 130 by the privacy orchestrator 235 of FIG. 2.

At block 645, the API orchestrator 136 assesses the framework of the service provider website to determine whether an API is in use. In the event that the API orchestrator 136 determines that an API is in use by the service provider website (e.g., the control of block 645 returns a result of YES), the process moves on to block 655.

Alternatively, in the event that the API orchestrator 136 determines that an API is not in use by the service provider website (e.g., the control of block 645 returns a result of NO), the process moves onto block 650.

At block 650, the API orchestrator 136 notifies the privacy orchestration agent 101 that an API is not in use by the service provider.

At block 655, the federated identity linker 135 uses shared authentication to link information across multiple different service provider websites to allow for the secure transmission of data to another service provider website without user entry.

At block 660, the per service periodic cleaner 131 adds the user personal information (e.g., sent by the per service personal information racer 225) to the comprehensive list of service providers with access to user personal information. Process 635 is then stopped.

Subsection 662 begins at block 665, where the per service periodic cleaner 131 of FIG. 1 receives a request to revoke a service provider's access to user personal data. In the examples disclosed herein, the per service periodic cleaner 131 receives the request for revocation from the privacy orchestrator 235 of FIG. 2.

At block 670, the per service periodic cleaner 131 of FIG. 1 completes the revocation of data by no longer decrypting user personal data each time the data is to be used by a service provider. By only allowing a service provider to have access to encrypted user personal data, the per service periodic cleaner 131 may easily stop the decryption process to revoke, at any time, a service provider's ability to access user personal information.

Responsive to the instructions executed at block 670, the per service periodic cleaner 131 updates the internal list of service providers with access to user personal information. Process 635 is then stopped.

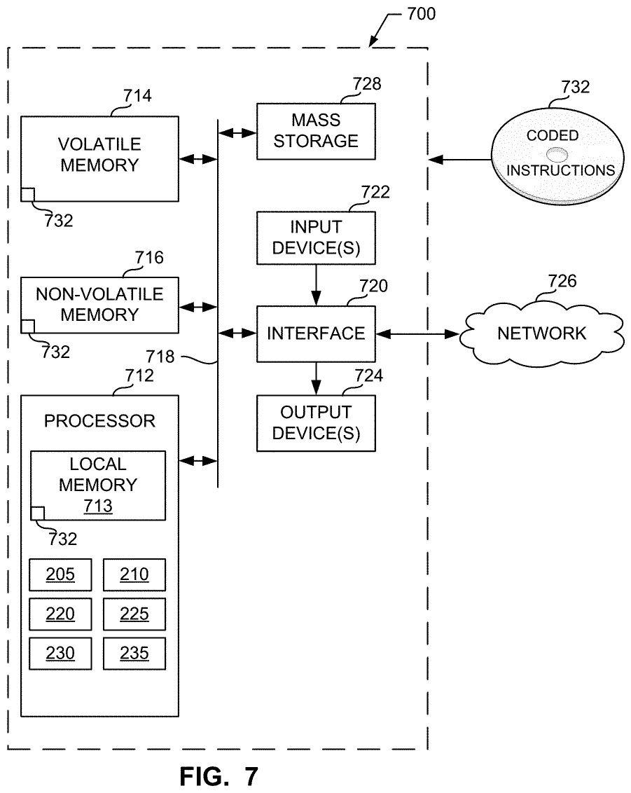

FIG. 7 is a block diagram of an example processor platform 700 structured to execute the instructions of FIG. 3 to implement the privacy orchestration agent 101 of FIGS. 1 and/or 2. The processor platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computer device.

The processor platform 700 of the illustrated example includes a processor 712. The processor 712 of the illustrated example is hardware. For example, the processor 712 can be implemented by one or more integrated circuits, logic circuits, microprocessors, GPUs, DSPs, or controllers from any desired family or manufacturer. The hardware processor may be a semiconductor based (e.g., silicon based) device. In this example, the processor 712 implements the user notifier 205, the user interface 210, the DOM parser 215, the context handler 220, the per service personal information tracer 225, the privacy policy analyzer 230, and the privacy orchestrator 235.

The processor 712 of the illustrated example includes a local memory 713 (e.g., a cache). The processor 712 of the illustrated example is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 716 may be implemented by flash memory and/or any other desired type of memory device. Access to the main memory 714, 716 is controlled by a memory controller.

The processor platform 700 of the illustrated example also includes an interface circuit 720. The interface circuit 720 may be implemented by any type of interface standard, such as an Ethernet interface, a universal serial bus (USB), a Bluetooth® interface, a near field communication (NFC) interface, and/or a PCI express interface.

In the illustrated example, one or more input devices 722 are connected to the interface circuit 720. The input device(s) 722 permit(s) a user to enter data and/or commands into the processor 712. The input device(s) can be implemented by, for example, an audio sensor, a microphone, a camera (still or video), a keyboard ,a button, a mouse, a touchscreen, a track-pad, a trackball, isopoint, and/or a voice recognition system.

One or more output devices 724 are also connected to the interface circuit 720 of the illustrated example. The output devices 724 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 720 of the illustrated example, thus, typically includes a graphics driver card, a graphics driver chip and/or a graphics driver processor.

The interface circuit 720 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 726. The communication can be via, for example, an Ethernet connection, a digital subscriber line (DSL) connection, a telephone line connection, a coaxial cable system, a satellite system, a line-of-site wireless system, a cellular telephone system, etc.

The processor platform 700 of the illustrated example also includes one or more mass storage devices 728 for storing software and/or data. Example of such mass storage devices 728 include floppy disk drives, hard drive disks, compact disk drives, Blu-ray disk drives, redundant array of independent disks (RAID) systems, and digital versatile disk (DVD) drives.

The machine executable instructions 732 of FIG. 3 may be stored in the mass storage device 728, in the volatile memory 714, in the non-volatile memory 716, and/or on a removable non-transitory computer readable storage medium such as a CD or DVD.

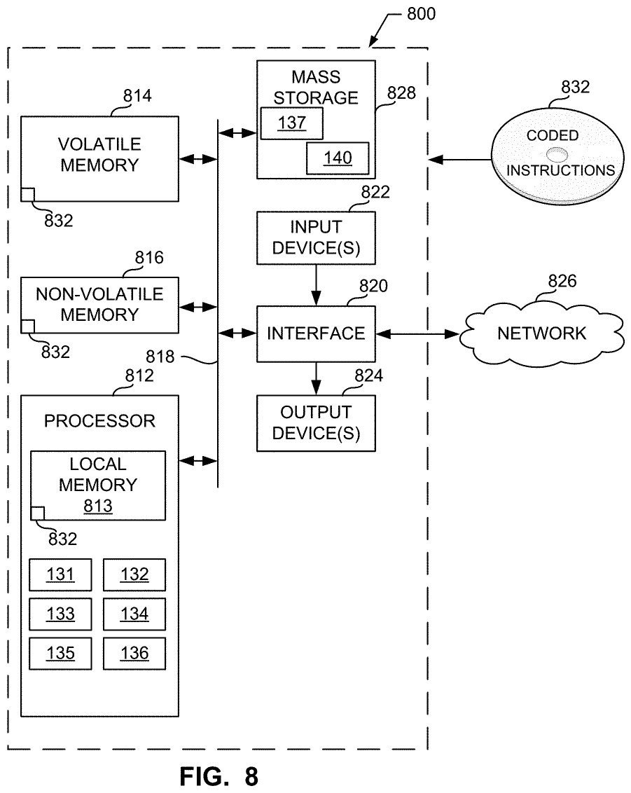

FIG. 8 is a block diagram of an example processor platform 800 structured to execute the instructions of FIGS. 4-6b to implement the privacy orchestration engine 130 of FIG. 1. The processor platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computer device.

The processor platform 800 of the illustrated example includes a processor 812. The processor 812 of the illustrated example is hardware. For example, the processor 812 can be implemented by one or more integrated circuits, logic circuits, microprocessors, GPUs, DSPs, or controllers from any desired family or manufacturer. The hardware processor may be a semiconductor based (e.g., silicon based) device. In this example, the processor 812 implements the per service periodic cleaner 131, the engine user notifier 132, the privacy policy interpreter 133, the service reputation checker 134, the federated identity linker 135, and the API orchestrator 136.

The processor 812 of the illustrated example includes a local memory 813 (e.g., a cache). The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes an interface circuit 820. The interface circuit 820 may be implemented by any type of interface standard, such as an Ethernet interface, a universal serial bus (USB), a Bluetooth® interface, a near field communication (NFC) interface, and/or a PCI express interface.

In the illustrated example, one or more input devices 822 are connected to the interface circuit 820. The input device(s) 822 permit(s) a user to enter data and/or commands into the processor 812. The input device(s) can be implemented by, for example, an audio sensor, a microphone, a camera (still or video), a keyboard ,a button, a mouse, a touchscreen, a track-pad, a trackball, isopoint, and/or a voice recognition system.

One or more output devices 824 are also connected to the interface circuit 820 of the illustrated example. The output devices 824 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 820 of the illustrated example, thus, typically includes a graphics driver card, a graphics driver chip, and/or a graphics driver processor.

The interface circuit 820 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 826. The communication can be via, for example, an Ethernet connection, a digital subscriber line (DSL) connection, a telephone line connection, a coaxial cable system, a satellite system, a line-of-site wireless system, a cellular telephone system, etc.

The processor platform 800 of the illustrate example also includes one or more mass storage devices 828 for storing software and/or data. Example of such mass storage devices 828 include floppy disk drives, hard drive disks, compact disk drives, Blu-ray disk drives, redundant array of independent disks (RAID) systems, and digital versatile disk (DVD) drives. The example mass storage device 828 includes the user data database 137 and the service reputation database 140.

The machine executable instructions 832 of FIGS. 4-6b may be stored in the mass storage device 828, in the volatile memory 814, in the non-volatile memory 816, and/or on a removable non-transitory computer readable storage medium such as a CD or DVD.

A block diagram illustrated an example software distribution platform 905 to distribute software such as the example readable instructions 732 of FIG. 3 to third parties is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform. For example, the entity that owns and/or operates the software distribution platform may be a developer, a seller, and/or a licensor of software such as the example computer readable instructions 732 of FIG. 3. The third parties may be consumers, users, retailers, OEMs, etc., who purchase and/or license the software for use and/or re-sale and/or sub-licensing. In the illustrated example, the software distribution platform 905 includes one or more server and one or more storage devices. The storage devices store the computer readable instructions 732, which may correspond to the example computer readable instructions 300 of FIG. 3, as described above. The one or more servers of the example software distribution platform 905 are in communication with a network 910, which may correspond to any one or more of the Internet and/or any of the example networks (e.g., the Internet 150 of FIG. 1) described above. In some examples, the one or more servers are responsive to requests to transmit the software to a requesting party as part of a commercial transaction. Payment for the delivery, sale, and/or license of the software may be handled by the one or more servers of the software distribution platform and/or via a third party payment entity. The servers enable purchasers and/or licensors to download the computer readable instructions 732 from the software distribution platform 905. For example, the software, which may correspond to the example computer readable instructions 300 of FIG. 3 may be downloaded to the example processor platform 700, which is to execute the computer readable instructions 732 to implement the privacy orchestration agent 101. In some examples, one or more servers of the software distribution platform 905 periodically offer, transmit, and/or force updates to the software (e.g., the example computer readable instructions 732 of FIG. 7) to ensure improvements, patches, updates, etc. are distributed and applied to the software at the end user devices.

A block diagram illustrated an example software distribution platform 1005 to distribute software such as the example readable instructions 832 of FIGS. 4-6b to third parties is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform. For example, the entity that owns and/or operates the software distribution platform may be a developer, a seller, and/or a licensor of software such as the example computer readable instructions 832 of FIGS. 4-6b. The third parties may be consumers, users, retailers, OEMs, etc., who purchase and/or license the software for use and/or re-sale and/or sub-licensing. In the illustrated example, the software distribution platform 1005 includes one or more server and one or more storage devices. The storage devices store the computer readable instructions 832, which may correspond to the example computer readable instructions 400, 500, 600, 635 of FIGS. 4, 5, 6a, and/or 6b, as described above. The one or more servers of the example software distribution platform 1005 are in communication with a network 1010, which may correspond to any one or more of the Internet and/or any of the example networks (e.g., the Internet 150 of FIG. 1) described above. In some examples, the one or more servers are responsive to requests to transmit the software to a requesting party as part of a commercial transaction. Payment for the delivery, sale, and/or license of the software may be handled by the one or more servers of the software distribution platform and/or via a third party payment entity. The servers enable purchasers and/or licensors to download the computer readable instructions 832 from the software distribution platform 1005. For example, the software, which may correspond to the example computer readable instructions 400, 500, 600, 635 of FIGS. 4, 5, 6a, and/or 6b may be downloaded to the example processor platform 800, which is to execute the computer readable instructions 832 to implement the privacy orchestration engine 130. In some examples, one or more servers of the software distribution platform 1005 periodically offer, transmit, and/or force updates to the software (e.g., the example computer readable instructions 832 of FIG. 8) to ensure improvements, patches, updates, etc. are distributed and applied to the software at the end user devices.

From the foregoing, it will be appreciated that example methods, apparatus, and articles of manufacture have been disclosed that improve the management and protection of data transactions between a user and multiple service provider(s) by providing a single interface containing information about at least user data distribution, data security, and/or service provider reputation, giving users the ability to revoke data from any service provider at any time, allowing for single data entry across multiple service provider websites, and/or prescreening all service providers to ensure data security.

Although certain example methods, apparatus, and articles of manufacture have been disclosed herein, the scope of coverage of this patent is not limited thereto. On the contrary, this patent covers all methods, apparatus, and articles of manufacture fairly falling within the scope of the claims of this patent.

The following claims are hereby incorporated into this Detailed Description by this reference, with each claim standing on its own as a separate embodiment of the present disclosure.

What is claimed is:

1. A non-transitory computer readable medium comprising instructions that, when executed, cause a machine to at least:
encrypt user personal information for storage in a user information database;
identify a request for personal information from a service provider;
determine a reputation score of the service provider using a service reputation database;
compare the reputation score against a threshold for reputability;
cause presentation of a request for approval to provide user information to the service provider;
in response to user approval, provide the user information to the service provider; and
add the service provider to a list of service providers that have been given access to user information.

2. The non-transitory computer readable medium of claim 1, wherein the instructions, when executed, cause the machine to:
analyze the list of service providers with access to user personal information; and
send a reminder to revoke access from the service provider from the list of service providers.

3. The non-transitory computer readable medium of claim 2, wherein the instructions, when executed, cause the machine to, upon approval to revoke access, remove access to user personal information for the service provider.

4. The non-transitory computer readable medium of claim 1, wherein the instructions, when executed, cause the machine to warn the user about the reputability of a service provider before sending personal information.

5. The non-transitory computer readable medium of claim 1, wherein the instructions, when executed, cause the machine to prompt the user to enter personal information requested by the service provider that is not already stored in the user information database.

6. The non-transitory computer readable medium of claim 1, wherein the instructions, when executed, cause the machine to provide the user information to the service provider by providing the user information via a federated link with the service provider.

7. The non-transitory computer readable medium of claim 1, wherein the instructions, when executed, cause the machine to provide the user information to the service provider by providing the user information via an application programming interface provided by the with the service provider.

8. The non-transitory computer readable medium of claim 1, wherein the user information database and service reputation database are implemented in a single database.

9. A method for handling user personal information, the method comprising:
encrypting user personal information for storage in a user information database;
identifying a request for personal information from a service provider;
determining a reputation score of the service provider using a service reputation database;
comparing the reputation score against a threshold for reputability;
causing presentation of a request for approval to provide user information to the service provider;
in response to user approval, providing the user information to the service provider; and
adding the service provider to a list of service providers that have been given access to user information.

10. The method of claim 9, further including:
analyzing the list of service providers with access to user personal information; and
sending a reminder to revoke access from the service provider from the list of service providers.

11. The method of claim 10, further including, upon approval to revoke access, removing access to user personal information for the service provider.

12. The method of claim 9, further including warning the user about the reputability of a service provider before sending personal information.

13. The method of claim 9, further including prompting the user to enter personal information requested by the service provider that is not already stored in the user information database.

14. The method of claim 9, wherein providing the user information to the service provider includes providing the user information via a federated link with the service provider.

15. The method of claim 9, wherein providing the user information to the service provider includes providing the user information via an application programming interface provided by the with the service provider.

16. The method of claim 9, wherein the user information database and service reputation database are implemented in a single database.

17. An apparatus comprising:
a service reputation checker to:
determine a reputation score of a service provider associated with a request using a service reputation database; and
compare the reputation score against a threshold for reputability;
a user notifier to cause presentation of a request for approval to provide user information to the service provider;
at least one of a federated identifier linker or an application programming interface orchestrator to, in response to user approval, provide the user information to the service provider; and
a user data database to store an indication of the service provider in a list of service providers that have been given access to user information.

18. The apparatus of claim 17, further including a per service periodic cleaner to:
analyze the list of service providers with access to user personal information; and
send a reminder to revoke access from the service provider from the list of service providers.

19. The apparatus of claim 18, wherein the per service periodic cleaner is to, upon approval to revoke access, remove access to user personal information for the service provider.

20. The apparatus of claim 17, wherein the user notifier is to warn the user about the reputability of a service provider before sending personal information.

21. The apparatus of claim 17, wherein the federated identifier linker is to provide the user information to the service provider by providing the user information via a federated link with the service provider.

22. The apparatus of claim 17, wherein the application programming interface is to provide the user information to the service provider by providing the user information via an application programming interface provided by the with the service provider.
